(19) United States
(12) Patent Application Publication
(10) Pub. No.: US 2024/0262230 A1
(43) Pub. Date: Aug. 8, 2024

(54) STANDALONE DEVICE FOR RECHARGING ELECTRICAL ENERGY STORAGE MEANS OF A VEHICLE

(71) Applicant: MOB-ENERGY, LYON (FR)

(72) Inventors: Ilyass HADDOUT, VILLEURBANNE (FR); Maxime ROY, VILLEURBANNE (FR); Salim EL HOUAT, LYON (FR); Habib BEN OTHMEN, LYON (FR)

(21) Appl. No.: 18/554,716

(22) PCT Filed: Apr. 12, 2022
(86) PCT No.: PCT/EP2022/059777

§ 371 Date: May 1, 2024

(30) Foreign Application Priority Data
Apr. 12, 2021 (FR) FR2103752

(51) Int. Cl. B60L 53/37; B60L 53/302; B60L 53/53; G06V 20/50

(52) U.S. Cl. CPC B60L 53/37; B60L 53/302; B60L 53/53; G06V 20/50

(57) ABSTRACT

The invention relates to a standalone device for charging/recharging electrical energy storage means of a vehicle, the standalone device extending vertically in a vertical direction A-A′, the standalone device including a coupling system suitable for cooperating with a coupling module positioned on the ground, said coupling system comprising: —a connecting member (41) for electrically connecting the standalone device to the coupling module, and —moving means (43) for translating the connecting member (41) in the direction A-A′ between a retracted position and an extended position, the connecting member (41) being closer to the ground in the extended position than in the retracted position.

### FIELD OF THE INVENTION

The present invention relates to the technical field of standalone devices allowing charging/recharging the electrical energy storage means of a vehicle comprising an electric motor.

A system of this type can particularly, but not exclusively, be used for charging/recharging storage means in an environment with limited space, such as a parking lot composed of off-street parking and/or of on-street parking.

What is meant within the scope of the present invention by “off-street parking” are organized parking lots in delimited locations in an enclosed space with controlled access, such as an elevated, underground or surface parking lot. What is meant by “on-street parking” are parking lots organized in locations—delimited or not—in an open space, paid or free.

### BACKGROUND OF THE INVENTION

Known within the prior art is document U.S. Pat. No. 9,592,742 describing a device with a cubical shape, motorized and equipped with different output cables, which can be moved on a parking lot to the vicinity of an electric vehicle. This device allows recharging an electric vehicle from batteries stored in the device. One disadvantage of this solution is that it requires human intervention in order to connect the device to the vehicle.

Also known is document U.S. Pat. No. 9,778,653 describing methods and systems for transferring energy from a standalone driverless unit to an electric vehicle. The electric vehicle issues a recharge order, and the driverless standalone unit meets it at a rendezvous point, attaches itself to the electric vehicle and allows transferring energy. One disadvantage of this solution is that the use of a drone (as described in FIG. 6 of U.S. Pat. No. 9,778,653) to transport batteries poses safety problems. In addition, this solution is not suitable for enclosed spaces.

Also known from document KR 2020/0037548 is a solution for charging/recharging a vehicle based on the use of a standalone charging/discharging robot containing batteries, as well as a magnetized interfacing box. The interfacing box comprises a connecting outlet intended to receive one of the ends of an electrical connection cable, the other end of the cable being intended to be linked to the storage means of the vehicle to be charged/recharged. The principle of operation of the solution described in KR 2020/0037548 is the following. The user places the magnetized interfacing box at the license plate of the electric vehicle and orders that it be recharged. As a result of this order, the standalone robot moves to the vicinity of the vehicle and comes into contact with the interfacing box to allow the transfer of electrical energy to the electrical energy storage means of the vehicle. One disadvantage of this solution described in KR 2020/0037548 is that there is a risk of degradation of the vehicle during the coupling of the charging robot to the interfacing box.

One object of the present invention is to propose a standalone device for charging/recharging electrical energy storage means of a vehicle that allows mitigating at least one of the aforementioned disadvantages.

### BRIEF DESCRIPTION OF THE INVENTION

To this end, the invention proposes an standalone device for charging/recharging electrical energy storage means of a vehicle, the standalone device extending vertically in a vertical direction A-A′ and comprising:
a movable pedestal including wheels for moving the standalone device in the ground,
a chassis mounted on the movable pedestal, the chassis being suitable for accommodating batteries,
a fairing around the chassis, the fairing comprising a reception bay for a coupling module electrically connected to the electrical energy storage means of the vehicle,
a coupling system housed in the reception bay, the coupling system being suitable for cooperating with the coupling module,
   characterized in that the coupling system comprises:
a connection member for electrically connecting the standalone device to the coupling module, and
movement means for moving the connection member in translation in the direction A-A′ between a retracted position and a deployed position, the connection member being closer to the ground in the deployed position than in the retracted position.

Preferred but non-limiting aspects of the movable device according to the invention are the following:
the movement means can comprise at least one stepper motor;
the connection member can comprise:
   at least one support base having an electrical connector intended to be connected electrically to a complementary electrical outlet provided in the coupling module,
   at least one centering plate extending parallel to the support base, the centering plate being positioned below the support base so that the centering plate is farther from the chassis than the support base,
   at least one elastic return element between the support base and the centering plate,
so that the centering plate is mounted movable in translation relative to the support base;
the connection member can also comprise:
   at least one position sensor for detecting whether the connection member is in the retracted position or in the deployed position,
at least one presence sensor for detecting the presence and the positioning of the coupling module;
each elastic return element can comprise:
   a helical spring, one of the ends of the helical spring being attached to the support base, and the other of the ends of the helical spring being attached to the centering plate, and
   a guide rod extending inside the helical spring, the guide rod being attached to the centering plate so as to extend perpendicular to it, the support base including a through slot for the passage of the guide rod, the free end of the guide rod comprising an abutment extending in front of a face of the support base opposite to the centering plate;
the centering plate can comprise at least one alignment pin protruding toward the outside of a face of the centering plate opposite to the support base, said pin being intended to cooperate with a blind hole with a complementary shape provided in the coupling module;
each pin can have a partially or totally frusto-conical shape;
the coupling system can also comprise guide means for guiding the movement in translation of the connection member, said guide means including a pair of parallel threaded bars, each threaded bar being suitable for cooperating with a respective tapped opening provided in the support base, so that the rotation of the threaded bars induces the movement in translation of the connection member,
the device can comprise a cooling circuit, said cooling circuit including:
   an air intake zone positioned in a lower region of the chassis near the movable pedestal,
   an air discharge zone positioned in an upper region of the chassis farther from the movable pedestal than the lower region of the chassis;
as a variant, the device can comprise a cooling circuit, said cooling circuit including:
   an air intake zone comprising through openings provided in first panels of the fairing,
   an air discharge zone comprising through openings provided in second panels of the fairing different from the first panels;
the device can also comprise image acquisition means for the detection of objects of interest in the environment of the standalone device, said image acquisition means including monocular cameras positioned at a respective lateral face of the fairing.

### BRIEF DESCRIPTION OF THE DRAWINGS

Other advantages and features of the standalone device according to the invention will be best revealed by the description that follows of several variant embodiments, given by way of non-limiting examples, based on the appended drawings in which:

FIG. 1 is a perspective view of the standalone device according to the invention,

FIG. 2 is a side view of the standalone device of FIG. 1,

FIG. 3 is a front view of the standalone device of FIG. 1,

FIG. 4 is a schematic view of the standalone device of FIG. 1,

FIG. 5 is a front view of a coupling system of the standalone device,

FIG. 6 is a perspective view of the coupling system illustrated in FIG. 5.

### DETAILED DESCRIPTION OF THE INVENTION

Different exemplary embodiments of the invention will now be described with reference to the figures. In these different figures, equivalent elements are designated by the same numerical label.

### 1. STANDALONE DEVICE

### 1.1. Presentation

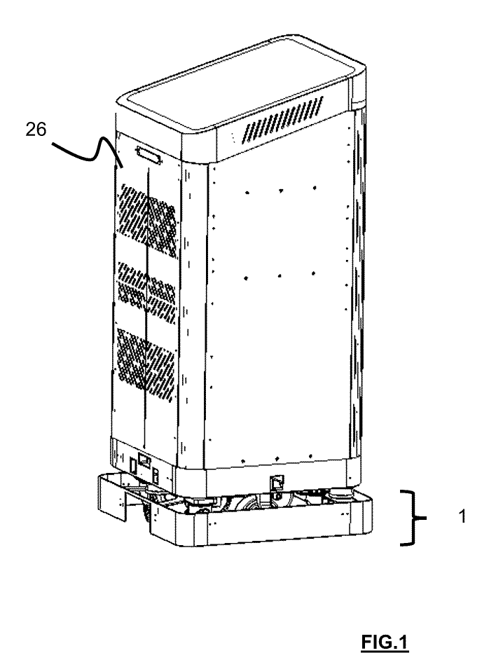

With reference to FIGS. 1 to 4, the standalone device includes:
a movable pedestal 1 integrating wheels 11 for moving the standalone device,
a chassis 2 mounted on the movable pedestal, the chassis being configured to accommodate different components of the standalone device, such as:
   batteries 21,
   power converters 22,
   a cooling circuit,
   image acquisition means, etc.
a fairing 26 around the chassis, and
a coupling system to allow electrically connecting the standalone device to the electrical energy storage means of a vehicle.

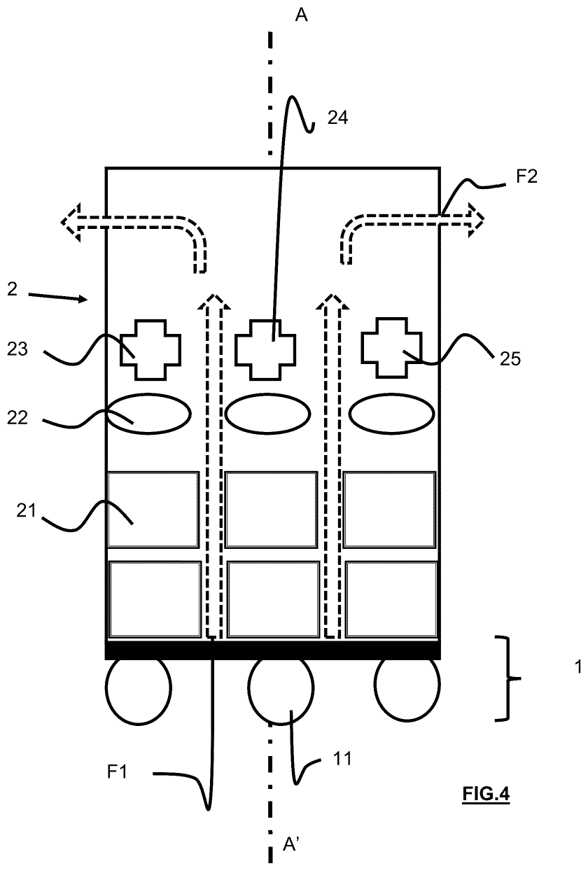

As illustrated in FIG. 4, the standalone device extends vertically along an axis A-A′. It allows charging/recharging the storage means of an electric vehicle by means of a coupling module (independent element) connecting to the electric vehicle by means of an electrically conducting cable (operation executed by the user of the electric vehicle), and having a facade configured to match with the coupling system without outside intervention in order to ensure the passage—by wire or by induction—of electrical energy from the standalone device to the coupling module. This electrical energy is then transmitted to the storage means of the vehicle by means of the cable.

More precisely, the coupling system comprises an electrical connection member able to move in vertical translation to connect itself to the coupling module, as will be described in more detail hereafter.

The fact that the connection of the standalone device is accomplished “on the ground” via the movement in vertical translation of a connection member allows limiting the risks of degradation of the vehicle, particularly relative to a standalone charging/discharging solution based on the connection of a charge/recharge device directly with the vehicle (or with a coupling module attached to the vehicle).

### 1.2. General Elements of the Device

### 1.2.1. Movable Pedestal

The movable pedestal 1 can be of the type described in French patent application FR2100632 filed by the applicant.

A movable pedestal 1 of this type comprises a frame (not shown) and driven and idler wheels 11 to allow the movement of the standalone device.

In particular, the movable pedestal 1 comprises two driven wheels and four idler rollers arranged by triplets, the wheel and the two rollers of each triplet being aligned along a respective longitudinal edge of the movable pedestal. A first roller of each triplet is mounted at one end of the frame. The driven wheel and the second idler roller are, for their part, attached to an oscillating member mounted pivotingly on the frame around a pivoting axis perpendicular to a longitudinal axis of the pedestal.

A movable pedestal of this type, which is known from FR2100632, will not be described in more detail hereafter.

### 1.2.2. Chassis

The chassis 2 serves as a support for the different components constituting the standalone device. The chassis 2 is produced from tubes defining a skeleton for the standalone device.

In the embodiment illustrated in FIG. 4, the chassis 2 has the overall shape of a parallelepiped. It is composed:
of a “lower portion” intended to be attached to the movable pedestal,
of a “central portion” suitable for containing different components of the standalone device,
of an “upper portion” opposite to the lower portion and corresponding to the “head” of the standalone device.

The chassis 2 is configured to accommodate storage batteries 21 allowing electrical energy to be stored for the purpose of charging/recharging the storage means of the vehicle. These batteries 21 are preferably positioned in a portion—called the “lower portion”—of the chassis 2 closest to the ground. In fact the batteries 21 of the standalone device being the heaviest components, it is preferable to position them in proximity to the ground to optimize the stability of the standalone device.

The chassis 2 is also configured to accommodate:
power converters 22 (i.e. AC/DC and DC/AC converters),
image acquisition means (such as cameras, or any other sensor known to a person skilled in the art),
a control unit 23 for processing the images acquired by the acquisition means, and for controlling the components of the standalone device,
memories 24 for storing information,
communication means 25 for allowing the exchange of information between the standalone device and a remote management center,
means for cooling the components of the standalone device.

The different original elements of the standalone device and their associated advantages will be described in more detail hereafter.

### 1.2.3. Fairing

The fairing 26 consists of one or more sheet-metal parts attached to the chassis 2 of the standalone device. The fairing 26 allows improving the esthetics of the standalone device by “clothing” the components constituting it. The fairing 26 also allows protecting components from possible external attacks.

In the embodiment illustrated in FIGS. 1 to 3, the fairing 26 is composed:
of four lateral panels intended to cover the lateral faces of the chassis, and
of a cover intended to cap the upper face of the chassis.

With reference to FIGS. 1 to 3, the fairing comprises a cavity defining a reception bay of the coupling module. Advantageously, the coupling system is contained in this bay. Thus, to establish a connection with the storage means of the vehicle, the standalone device moves up to the coupling module and orients itself so as to make the coupling module penetrate into the reception bay. Once the coupling module is housed in the reception bay, the control unit commands the movement of the connection member to connect it electrically to the coupling module. The fact of accomplishing the electrical connection in the reception bay allows increasing the safety of the device by limiting the accessibility to the user of the connection member and of the coupling module.

The coupling system of the standalone device according to the invention will now be described in more detail.

### 1.2.4. Cooling Circuit

As previously indicated, the standalone device comprises a cooling circuit allowing limiting the heating of its components. In fact, the possible:
electronic cards,
batteries, and
power converters contained in the chassis,
   dissipate a considerable quantity of heat, causing a significant increase in their temperature. Yet too great an increase in the temperature of these elements can cause a reduction in their reliability and/or reduce their lifetimes. That is why the standalone device comprises a cooling circuit in order to effectively discharge the heat dissipated by its different components.

The cooling circuit comprises heat-transfer fluid circulation ducts arranged in the chassis of the standalone device, between the movable pedestal and the top of the chassis opposite to the movable pedestal.

The circulation ducts can be flexible tubes (made for example of glycolized polyester) to facilitate their installation in the chassis between the different components (batteries, power converters, control unit, etc.). As a variant, the circulation ducts can be rigid (made of copper for example).

The heat-transfer fluid can for example be an oil, an alcohol (such as methanol, ethanol or glycol), an organic compound (such as acetone, ammonia), a mixture, a nanofluid, a liquid metal, demineralized water or any type of heat-transfer fluid known to a person skilled in the art.

The cooling circuit also comprises a cold air intake zone F1 positioned at the lower portion of the chassis (i.e. at the movable pedestal), and a hot air discharge zone F2 positioned at the upper portion of the chassis (i.e. at the end of the chassis opposite to the movable pedestal). The cold air intake zone F1 can comprise 1 (or more) filter(s) to limit the risk of introducing dust into the standalone device. Likewise, the hot air discharge zone F2 can comprise one (or more) filter(s) to limit the discharge of impurities to the outside of the standalone device.

The fact of recovering cold air in the lower portion of the chassis and discharging hot air into the upper portion of the chassis allows improving the cooling of the device, hot air having a tendency to concentrate at a higher altitude than cold air.

Of course, the cooling circuit can comprise other elements, such as one (or more) heat exchanger(s), one (or more) fan(s), etc.

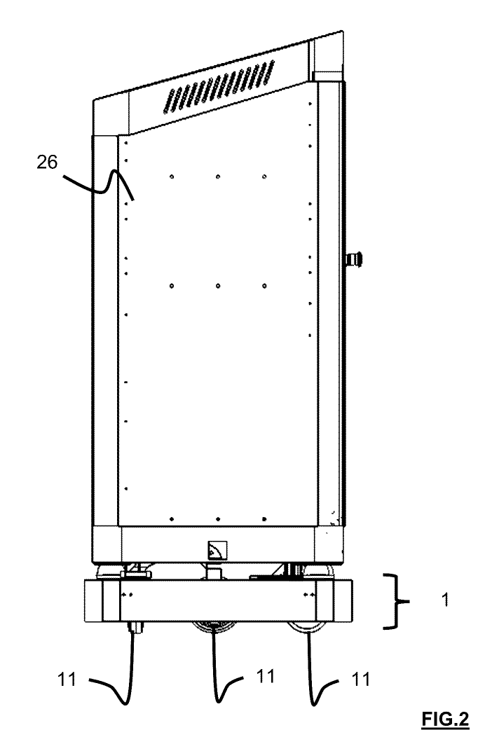

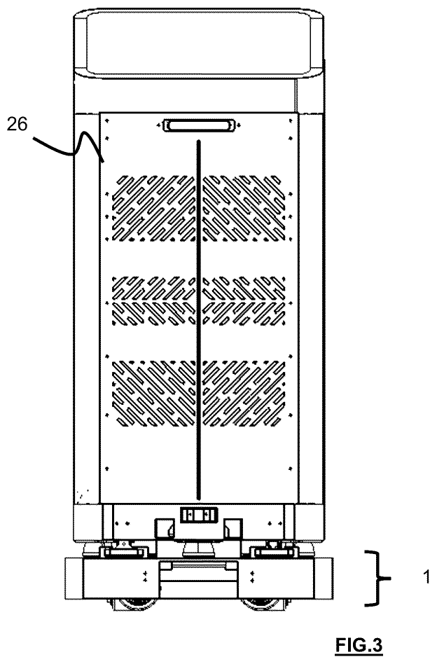

As a variant, the air intake F1 and air discharge F2 zones can each be provided in respective parallel lateral panels of the fairing 26. More precisely:
the air intake zone F1 can consist of through openings provided in the first parallel lateral panels of the fairing 26 defining a front and a rear of the movable device relative to its direction of movement (see FIG. 3),
the air discharge zone F2 can consist of through openings provided in the second parallel lateral panels (perpendicular to the first lateral panels) defining flanks of the standalone device relative to its movement direction (see FIG. 2).

### 1.2.5. Image Acquisition Means

The image acquisition means allow the standalone device to acquire images of its environment.

In the embodiment illustrated in FIGS. 1 to 3, the image acquisition means comprise a plurality of wide-angle monocular cameras. In particular, the standalone device comprises four cameras each positioned on a respective lateral face of the chassis in order to replicate a 360° view.

The images acquired by the monocular cameras are then processed by the control unit to detect obstacles, the position of the coupling module, the position of the vehicle, etc.

Of course, the standalone device can also comprise other types of sensors, such as distance sensors (laser, ultrasonic, radar, etc.) to estimate the distance between the standalone device and an object of interest (obstacle, vehicle, coupling module, etc.).

### 1.3. Coupling System

The coupling system comprises:
the electrical connection member 41, suitable for being moved in translation in a substantially vertical direction,
guide means 42 for guiding the movement in translation of the connection member,
means 43 for movement in translation of the connection member,
one (or more) position sensor(s) for detecting the position of the connection member (and in particular to detect whether the connection member is in a retracted position or in a deployed position, as will be described in greater detail hereafter),
one (or more) presence sensors for detecting the presence and the positioning of the coupling module.

### 1.3.1. Connection Member

The connection member 41 is configured to be moved between a retracted position and a deployed position. The connection member 41 being closer to the ground in the deployed position than in the retracted position.

More precisely:
in the retracted position, the connection member 41 extends (at least partially) in a housing provided in the movable charging/recharging device,
in the deployed position, the connection member protrudes from the housing,
   the connection member 41 being closer to the movement means 43 in the retracted position than in the deployed position.

The connection member 41 comprises:
a support base 411 on which is mounted an electrical connector,
a centering plate 412 extending parallel to the support base, the centering plate being farther from the movement means than the support base,
at least one elastic return element 413 between the support base 411 and the centering plate 412.

The centering plate 412 is able to move in translation relative to the support base 411. The elastic return element 413 allows maintaining the centering plate 412 at a predefined nonzero distance “d” from the support base 411 when no external force is exerted on the support base 411 and the centering plate 412.

When an external compression force (greater than a stiffness constant of the elastic return element) is applied to the support base 411 and the centering plate 412, the return element 413 is compressed and the support base 411 moves in translation toward the centering plate 412: the distance between the support base 411 and the centering plate 412 decreases. When the application of the external compression force is interrupted or becomes less than the stiffness constant of the elastic return element 413, the latter extends to its resting position: the support base 411 moves in translation in a direction opposite to the centering plate 412 until this support base 411 and the centering plate 412 are separated by the distance “d.”

### 1.3.2. Support Base

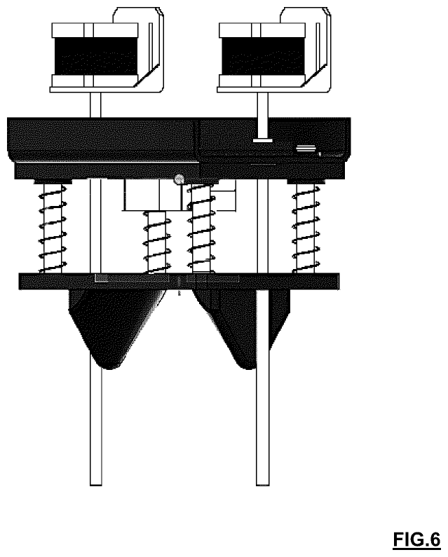

The support base 411 allows supporting the different components of the connection member 41. In the embodiment illustrated in FIG. 6, the support base 411 consists of a longitudinal section with a U-shaped cross-section. Of course, the support base 411 can have another shape (section with an L-, or H-shaped cross section, or even with a square, circular or rectangular cross section, etc.) or consisting for example of a substantially flat “support plate.”

The support base 411 comprises an electrical connector 4111 protruding from the face of the support base 411 facing the centering plate 412. This electrical connector 4111 allows the electrical connection of the connection member 41 to the coupling module for the passage of the electrical energy necessary for the charging/recharging of the storage means of the vehicle. More precisely, the electrical connector 4111 mounted on the support base 411 is configured to cooperate with an electrical outlet (with a complementary shape) mounted on the coupling module.

### 1.3.3. Centering Plate

The centering plate 412 allows providing the alignment between the electrical connector 4111 of the support base 411 and the electrical outlet of the coupling module.

The centering plate 412 is made of metal for example. It can have different shapes, such as a rectangular, square, parallelepiped, etc. shape.

The centering plate 412 comprises a through aperture allowing the passage of the electrical connector 4111 when the support base 411 and the centering plate 412 are in proximity to one another.

The centering plate 412 also comprises at least one alignment pin 4121 protruding toward the outside of its face opposite to the support base 411. This (these) alignment pin(s) 4121 allow(s) aligning the connection member 41 with the coupling module (to facilitate the connection of the electrical connector to the electrical outlet).

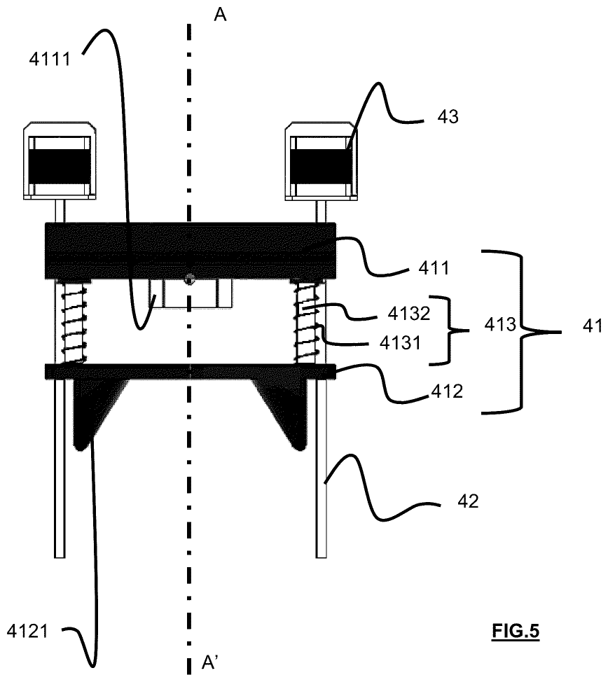

In the embodiment illustrated in FIGS. 5 and 6, the centering plate 412 comprises two alignment pins 4121 each mounted at a respective end of the centering plate. Each pin 4121 has a frusto-conical shape. More precisely, each alignment pin consists of a half-cone, the large base of which is attached to the centering plate 412. These alignment pins 4121 are each intended to cooperate with a respective blind hole of complementary shape provided in the coupling module.

### 1.3.4. Elastic Return Element

The elastic return element 413 is attached:
on the one hand, to the support base 411, and
on the other hand to the centering plate 412.

The elastic return element 413 can be of any type known to a person skilled in the art (air bladder, spring/damper, etc.).

In the embodiment illustrated in FIG. 5, the movable charge/recharge device comprises four return elements each consisting of a helical spring 4131 associated with a guide rod 4132 attached to the centering plate 412 and extending perpendicular to the centering plate 412 in the direction of the support base 411. Each helical spring 4131 is attached to the centering plate 412 by one of its ends, and to the support base 411 by its other end.

The support base 411 comprises four through slots for the passage of the guide rods 4132. Each guide rod 4132 is able to slide in its associated through slot when the distance between the support base 411 and the centering plate 412 varies.

Each guide rod 4132 comprises an abutment (not shown) at its free end. This abutment is positioned facing the face of the support base 411 opposite to the centering plate 412. The abutment is intended to come into contact with the support base 411 when the connection member 41 is in the retracted position. This abutment allows holding the guide rod 4132 in its associated through slot.

Preferably, each helical spring 4131 and its associated guide rod 4132 are positioned at a respective corner of the support base 411 and of the centering plate 412. This allows limiting the risks of pivoting of the support and centering plates 411, 412 with respect to one another.

### 1.3.5. Guide Means

The means 42 for guiding in translation can consist of one (or more) slider(s), one (or more) track(s) or any other means known to a person skilled in the art.

In the embodiment illustrated in FIG. 5, the guide means 42 consist of two threaded bars attached to the movement means 43 which will be described in more detail hereafter. The inventors have in fact discovered that this solution allowed limiting the stresses applied to the connection member, which facilitates its movement.

Each bar comprises a thread suitable for cooperating with a respective tapped opening provided in the support base. The rotation of the threaded bars by the movement means 43 induces the movement in translation of the connection member 41.

### 1.3.6. Movement Means

The movement means 43 allow moving the connection member 41 between the retracted and deployed positions.

These movement means 43 can comprise:
one (or more) hydraulic, electric, pneumatic, etc. actuator(s)
one (or more) DC motor(s),
one (or more) stepping motor(s),
or any other movement means known to a person skilled in the art.

Compared to the use of one (or more) actuator(s), the use of one (or more) stepping motor(s) allows limiting the bulk of the movement means, and therefore of the movable charging/recharging device.

Compared to the use of one (or more) DC motors, the use of one (or more) stepping motor(s) allows improving accuracy in the movement of the connection member. In fact, the movable charging/recharging device being intended to be used in a dirty environment such as a parking lot, it is possible that impurities may be lodged on the guide means. In this case, the duration of the movement of the connection member between the retracted and deployed positions may vary. With a DC motor, this variation in the duration of the movement can induce a reduction of the travel of the connection member (because the command setpoint of a DC motor is the duration of its activation). With a stepping motor, the command setpoint consisting of a number of revolutions, it is possible to control with greater accuracy the travel of the connection member between the retracted and deployed positions.

In the embodiment illustrated in FIGS. 5 and 6, the movement means 43 consist of two stepping motors positioned perpendicular to the connection member. More precisely, the two stepping motors extend facing the face of the support base opposite to the centering plate. These stepping motors are each positioned at one of the respective ends of the support base to limit the risks of pivoting the connection member during its movement in translation.

### 2. PRINCIPLE OF OPERATION

The principle of operation of the standalone device will now be described in more detail, with reference to the electrical connection of the standalone device with the coupling module.

It is assumed here that:
the coupling module was previously connected by the user to the electrical energy storage means of his vehicle by means of the electrically conducting cable, that
the module has been positioned on the ground, and that
the user has ordered the recharging of the storage means of his vehicle from a management service of the standalone device.

In a first step, the standalone device detects, by means of the image acquisition means, the coupling module associated with the vehicle for which the user desires to charge/recharge the energy storage means. This detection can be based on the color, the shape or any other technical solution known to a person skilled in the art for the detection of an object of interest.

The control unit 23 estimates the distance separating the standalone device from the coupling module and controls the movable pedestal to move the standalone device at a first speed. When the distance between the standalone device and the coupling module becomes less than a setpoint value—for example 3 meters—the control unit controls the movable pedestal to reduce the movement speed of the standalone device to a second speed that is less than the first speed.

The control unit 23 controls the movable pedestal to center the coupling module relative to the reception bay, and advances toward the coupling module so that the latter penetrates into the reception bay.

When the coupling system extends perpendicular to the coupling module (and in particular the connection member is above the coupling module), the control unit commands the immobilization of the standalone device.

The control unit 23 then commands the movement of the connection member 41 from the retracted position to the deployed position. The movement means 43 are activated and the coupling member 41 (support base, centering plate, elastic return element, etc.) moves vertically in the direction of the coupling module. The alignment pin(s) penetrate(s) into the blind hole(s) provided in the coupling module. The complementary frusto-conical shapes:
of the alignment pin(s) and
of the blind hole(s)
   allow (by friction during the introduction of the pin(s) into the blind hole(s)) adjusting the position of the coupling module relative to the connection member.

When the alignment pin(s) have (has) totally penetrated into the blind hole(s), the centering plate 412 is supported against the upper face of the coupling module. The connection member 41 continuing its travel toward the deployed position, the elastic return element(s) 413 are (is) compressed and the distance between the centering plate 412 and the support base 411 decreases. The guide rod 4132 of each return element 413 slides in the through slot of the support base 411 which is associated with it.

The distance between the support base 411 and the centering plate 412 continues to decrease until the electrical connector 4111 penetrates into the through aperture provided in the centering plate 412 and plugs itself into the electrical outlet (with a complementary shape) mounted on the coupling module.

When the electrical connector is plugged into the electrical outlet of the coupling module, the control unit 23 deactivates the movement means 43 and the charging/recharging of the storage means of the vehicle can begin.

Once the storage means of the vehicle are charged/recharged, the control unit 23 commands the movement of the connection member 41 from the deployed position to the retracted position. To accomplish this, the control unit 23 activates the movement means 43 of the coupling system.

The support base 411 moves vertically toward the chassis 2 of the standalone device. The compression force of the return element(s) 413 tends to hold the coupling module pressed against the ground. This facilitates the disengagement of the electrical connector, which detaches itself from the electrical outlet of the coupling module.

Once the return element(s) 413 have returned to their (its) resting position, the connection member 41 (i.e. support base, centering plate, elastic return element) moves vertically upward (i.e. toward the chassis) to reach the retracted position.

The standalone device can then move to charge/recharge the energy storage means of another vehicle.

### 3. CONCLUSIONS

The standalone device described previously allows charging/recharging the energy storage means of a vehicle in complete safety.

The reader will have understood that numerous modifications can be applied to the invention described previously without materially departing from the new teachings and the advantages described here.

1. A standalone device for charging/recharging electrical energy storage means of a vehicle, the standalone device extending vertically in a vertical direction A-A′ and comprising:
a movable pedestal including wheels for moving the standalone device on the ground,
a chassis mounted on the movable pedestal, the chassis accommodates batteries,
a fairing around the chassis, the fairing comprising a reception bay wherein the reception bay houses a coupling module electrically connected to the electrical energy storage means of the vehicle,
a coupling system housed in the reception bay, wherein the coupling system is configured for cooperating with the coupling module,
characterized in that the coupling system comprises:
a connection member configured for electrically connecting the standalone device to the coupling module, and
movement means configured for moving the connection member in translation in the vertical direction A-A′ between a retracted position and a deployed position, wherein the connection member is closer to the ground in the deployed position than in the retracted position.

2. The standalone device according to claim 1, wherein the movement means comprise at least one stepper motor.

3. The standalone device according to claim 1, wherein the connection member comprises:
at least one support base, wherein the support base has electrical connector configured to be connected electrically to a complementary electrical outlet provided in the coupling module,
at least one centering plate which extends parallel to the support base, wherein the centering plate is positioned below the support base so that the centering plate is farther from the chassis than the support base,
at least on elastic return element located between the support base and the centering plate,
so that the centering plate is mounted movable in translation relative to the support base.

4. The device according to claim 3, wherein the connection member also comprises:
at least one position sensor which detects whether the connection member is in the retracted position or in the deployed position,
at least one presence sensor which detects the presence and the positioning of the coupling module.

5. The standalone device according to claim 3, wherein each elastic return element comprises:
a helical spring, wherein one of the ends of the helical spring is attached to the support base, and the other of the ends of the helical is attached to the centering plate, and
a guide rod which extends inside the helical spring,
wherein the guide rod being is attached to the centering plate and extends perpendicular to the centering plate,
wherein the support base includes a through slot for the passage of the guide rod,
and wherein the free end of the guide rod comprises an abutment which extends in front of a face of the support base opposite to the centering plate.

6. The standalone device according to claim 3, wherein the centering plate comprises at least one alignment pin which protrudes toward the outside of a face of the centering plate opposite to the support base, and wherein said pin cooperates with a blind hole with a complementary shape provided in the coupling module.

7. The standalone device according to claim 6, wherein each pin has a partially or totally frusto-conical shape.

8. The standalone device according to claim 1, wherein the coupling system also comprises guide means which guides the movement in translation of the connection member, and wherein said guide means includes a pair of parallel threaded bars which cooperates with a respective tapped opening provided in the support base, so that the rotation of the threaded bars induces the movement in translation of the connection member.

9. The standalone device according to claim 1, which also comprises a cooling circuit, said cooling circuit including:
an air intake zone positioned in a lower region of the chassis near the movable pedestal,
an air discharge zone positioned in an upper region of the chassis farther from the movable pedestal than the lower region of the chassis.

10. The standalone device according to claim 1, which also comprises a cooling circuit, said cooling circuit including:
an air intake zone which has through openings provided in first panels of the fairing,
an air discharge zone which has through openings provided in second panels of the fairing, different from the first panels.

11. The standalone device according to claim 1, which also comprises image acquisition means configured for the detection of objects of interest in the environment of the standalone device, wherein said image acquisition means include monocular cameras each positioned at a respective lateral face of the fairing.
